(19) United States
(12) Patent Application Publication
(10) Pub. No.: US 2008/0301562 A1
(43) Pub. Date: Dec. 4, 2008

(54) Systems and Methods for Accelerating Access to Web Resources by Linking Browsers

(76) Inventors: Josef Berger, Santa Clara, CA (US); Sergey Armishev, Los Gatos, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 12/109,244

(22) Filed: Apr. 24, 2008

Related U.S. Application Data
(60) Provisional application No. 60/914,567, filed on Apr. 27, 2007.

(51) Int. Cl. G06F 3/00

(52) U.S. Cl. 715/733

(57) ABSTRACT

Retrieval of information and resources over the Internet is accelerated by automatically linking and synchronizing multiple device browsers in multiple tabs of device windows. The parallel tasks of access and execution, enables a client computerized device to search for information in parallel by activating multiple web sites' search engines, activating translation of web pages content by multiple translation engines at the same time and activating and deactivating a multiplicity of web resources in parallel. The method includes assigning multiple device browsers to multiple tabs in multiple device windows, thus enabling the efficient presentation of multiple web resources and enabling the user to speed the selection and switching between the accessed web resources displayed as tabs on device windows. Browsers linking topologies include; linking one to one, one to many, and many to many with unidirectional or two directional linking.

### CROSS-REFERENCE TO RELATED APPLICATIONS

This application claims the benefit of U.S. provisional patent application 60/914,567 filed on Apr. 27, 2007, entitled “Systems and Methods for linking browsers” and incorporates by reference the entire contents of the provisional application.

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION

(1) Field of the Invention

The invention generally relates to the use of device browsers for access web or intranet resources such as searching and processing information and in particularly to a system and method for linking and synchronizing device browsers for automatically access multiple web resources or intranet resources, and presenting them in multiple tabs and windows on clients computerized devices.

(2) Description of the Related Art

The development and expansion of the internet, the World Wide Web (Web) and device browsers, enable users of computerized devices to interact with information and resources located on the web. The browser is a software application that enables a user to navigate display and interact with web resources such as text, images, audiovisual content and other type of information and applications, located on websites on the World Wide Web or on local area network (Intranet). Many web resources such as web pages, audio content, audiovisual content, games content and verity of programs are generated and archived continuously on web sites located on web servers and connected via the internet to users' computerized devices.

Device browsers enable users an easy access to those web resources located in web sites on networked web servers. Computerized client devices are capable of running multiple device browsers in parallel where each one can access a different server and web site, retrieving and activating different web resource.

Each device browser can be activated in a separate device window or can be assigned to a different tab inside a device window. Thus, multiple device browsers can be activated simultaneously for example by activating multiple device browsers windows on the same client computerized device. The user can modify the device browser window dimensions and fits multiple windows on the same device display. Thus, the user can observe simultaneously presentations of retrieved and activated web resources content in each one of the open windows on its display.

Switching the window display presentation between browsers and their web resources became easier and faster following the introduction of multi-tabs window browsers. In the multi-tab browsers configuration, a user can select a tab associated with one of the active browsers and present the browser accessed web resource's content on the device window. The user can manually configure multiple windows to fit on the same device display and view multiple activated web resources with each active browser in its own window.

However, the manual process of configuring the operation of multiple device browsers and their set-up on the device display, is currently slow, complicated, inefficient and inconvenient. Consequently, there is a need to enable a faster, easier efficient and convenient activation and presentation of multiple browsers and web resources content simultaneously on computerized devices' displays.

In an example representing a general type of applications commonly used by users in the current art, a user can activate a first browser, retrieving information from a web site regarding a price of a stock. The user can also activate a second browser in a separate tab or a separate window, to retrieve and present a message-board, which discuss the same stock viewed in the first browser window.

However using the current art, the activation of browsers and the insertion of the stocks' symbol parameters in both browsers are done manually and serially. The user opens the first browser, inserting manually the required stock symbol and activates the web resource (e.g. web page) retrieving the stock value. Next, the user opens a second browser, search for example, for the message-board for the same stock, by inserting manually the same stock symbol. Then the user may arrange the two browsers windows presentations on the computerized device display, to allow both browsers and web resources presentations to be observed at the same time.

Moreover, using the current art, when the user changes parameters in the first browser, by for example inserting a second stock symbol in the first browser and retrieves the second stock price information, the second browser will continue to present the message board of the first stock, regardless the change of the stock type in the first browser. To change the second browser message board to a message board related to the second stock presented in the first browser the user has to search for the second stock message board on the second browser and activate it manually.

Consequently, there is a need to improve the current art slow and repetitive manual operations by methods and systems that automate the simultaneous presentations of related information accesses and retrieved by multiple browsers.

The current browsers related art limits the user's ability to create, archive, share and activate multiple browsers with automatic linked processes in between. An examples describing the need for activating multiple linking browsers simultaneously, occurs when users compare items prices offered at multiple web sites at the same time.

Web sites offerings may change in real time when online users purchase their merchandises. For example, the availability of flights tickets at certain prices depends on travelers' real time reservations. Thus, the flight reservation offerings information maybe updated in real time at the different web sites based on the tickets available, the remaining inventory and the real time price structure. Thus there is a need to allow users to automatically activate multiple resources for ease of real time comparison.

Hotels' online reservations' prices and room availability may change during the user's online search and comparison process. Rental car reservations may depends on the purchasing source and real time cars availability at different rental companies and pickup sites. Consequently, online users searching for information by activating multiple browsers at the same time for the real time search of products at multiple web sites, have a need to monitor simultaneously the retrieved information for the different products' offerings.

Thus, there is also a need to provide means for automate the manual activation of multiple browsers and the manual transfer of information and information parameters between browsers.

There is also a need to create default groups of linked browsers with prearranged linking configurations for common applications and easy adaptation by unsophisticated users. There is also a need to enable users to save and retrieve variety of prearranged linked groups' configurations that suite different applications and activate them on their computerized devices.

As described above in the flight reservation example, the search and comparison process for flights reservations requires the insertion of common parameters such as travel dates, user name and other user preferences. According to the current art, the user may browse each one of the travel web sites and repeat the manual insertion of the same flight parameters in all the browsed web sites. Moreover, when the user modifies parameters at one device browser the same modification, has to be repeated manually in the other web sites, during the search and comparison process. In certain case such as price and product comparisons, the user may decides to perform an iterative process, were the parameters inserted in the browser are derived from information or parameters previously retrieved by accessing web resources at other web sites. Currently this manual, repetitive insertion of parameters is slow tedious inefficient and vulnerable to errors. Consequently, there is a need to create a linking information entity that defines linking between user client device browsers for fast and efficient access and execution of multiple defined tasks.

There is also a need to create a browsers linking information entity that defines any shared parameters or correlated parameters that enables the synchronization of linked browsers and browsers' activated web resources. There is also a need for enabling the archiving of the created linking information entity on user's device as well as on remote server. There is also a need for enabling the retrieval of the linking information entity for the recreation of the device browsers linking configuration.

There is also a need for sharing the linking information entity, among device browsers located on different computerized devices for separate operations or distributed synchronized operation. There is also a need to enable users to edit the device browsers' linking information entity, to adapt it to their defined needs. There is also a need to optimize the linking information entity based on real time device browsers activity and the input or processed related information.

### BRIEF SUMMARY OF THE INVENTION

The present invention overcomes shortfalls in the related art by presenting systems and methods for linking between device browsers and creating user interface (UI) that manages the browsers, the accessed web resources and the related tabs and windows in a linked synchronized operation on client computerized devices. The linked browsers system and methods can be applied to personal computers, workstations, hand-held computerized devices, mobile phones, TV with internet access and other Internet and Intranet appliances.

The invention comprises methods for accelerating access to web resources by automatically activation of multiple web resources by linking and synchronizing simultaneously multiple device browsers in multiple tabs of device windows, the method comprises:

activating a first web resource using a first device browser and a first resource identifier in a first tab in a first device window;

creating linking information entities or retrieving linking information entities that define the linking parameters of said first resource identifier of said first web resource and other resources identifiers of other web resources;

activating the said other web resources using other device browsers and the other resource identifiers in other tabs in device windows; and

synchronizing the said parameters of the other device browsers with the parameters of the first device browser.

The general method of the current invention is applied to the linking of multiple browsers accessing multiple web resources in multiple web sites and presenting them in multiple windows and tabs either synchronously or asynchronously using variety of linking configurations.

The invention comprises a system for accelerating access to information by automatically activation of multiple web identifiable resources by linking and synchronizing multiple device browsers in multiple tabs of said device windows, the method comprises:

means for activating a first identifiable resource using a first device browser and a first resource identifier in a first tab in a first device window;

means for generating linking information entities or retrieving linking information entities that define the linking parameters of said first resource identifier of said first identifiable resource and other resources identifiers of other identifiable resources;

means for activating the other identifiable resources using other device browsers and the other resource identifiers in tabs in device windows; and

means for synchronizing the said parameters of the other device browsers with the parameters of the first device browser.

The general system of the current invention is applied to the linking of multiple browsers accessing multiple web resources in multiple web sites and presenting them in multiple windows and tabs either synchronously or asynchronously using variety of linking configurations.

The advantages of the invention are numerous. Different embodiments or implementations may yield one or more of the following advantages:
a. Linking a second browser to a first browser through a unidirectional link.
b. Linking a second browser to a first browser and linking the first browser to the second browser through a bidirectional links.
c. Linking multiple Browsers to a first browser with unidirectional links or with bidirectional links or with a mix of unidirectional and bidirectional links.
d. Linking of multiple browsers to multiple browsers with either unidirectional or bidirectional links or with a mix of unidirectional and bidirectional links.
e. Presenting the browsers' linking configuration in an easy to operate user interface, including having window's Add-on with multiple tabs for activating multiple browsers in a unified windows.
f. Enabling simple transferring of browsers between windows, between main window and window's Add-on and between window's add-on and main windows.
g. Enabling archiving and sharing of the linking information entity.
h. Applying the linking information entities to multiple device browsers located on multiplicity of devices.
i. Enabling the linking of browsers by activation of the linking information entities over distributed network of computerized devices.

The invention can be implemented in numerous ways including, a method, system, device, and a computer readable medium. Several embodiments of the invention are discussed below.

Other aspects and advantages of the invention will become apparent from the following detailed description taken in conjunction with the accompanying drawings which illustrate, by way of example, the principles of the invention.

### BRIEF DESCRIPTION OF THE DRAWINGS

FIG. 1 is a schematic presentation of a user interface displaying multiple linked browsers in tabs of device window and a window add-on of an exemplary embodiment of the present invention.

FIG. 2 is a general flow diagram of setting up the linking of browsers, of the current invention.

FIG. 3 is a general flow diagram of creating a linking information entity—run time.

FIG. 4 is a general Linking Information Entity setup—offline.

FIG. 5a. 5b. 5c. are general descriptions of exemplary linking relations and topologies between web resources.

### DETAILED DESCRIPTION

The present invention will be described in detail with specific reference to the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

Disclosed herein are system, method and computer-readable medium that enable linking Browsers. The browsers' linking process uses linking information entities, which define the browsers linking configurations and the related linking parameters. According to one embodiment of the current invention, a computerized device's user interface (UI) incorporates functionality that enables users to define the linking configuration of the device browsers. The system's user interface presents the defaults defined linked browsers and enables the user to modify or define its own linked browsers configurations.

The current invention also describes a novel user interface windows configuration, where windows are split to main window and window add-on, each presents web resources accessed by different browsers, wherein the browsers are linked and synchronized based on defined parameters. Users are capable of modifying the browsers linking information entities and the browsers presentation configurations using the current invention novel toolbar and functions keys presenting on the windows displays. Some of the novel functions keys include keys for set-up or disconnect linking for group of browsers or for individual browsers, modifying browsers locations between windows on a device display and book-marking linking configurations locally or on remote servers.

While the invention will be described in details with respect to linking device browsers, linking information entities, new user interface (UI) displays and functions keys, presentation of linked device browsers and related applications, access and activation of web resources (such as web pages, audio streaming, visual streaming, processes, program scripts, computer programs), archiving and sharing linking information entities, it should be understood that the invention is also applied to other types of linked browsers and related linked information resources accessed and processed by computerized devices programs.

Device browsers (browsers) are widely utilized by users of computerized devices for accessing and activating web resources over the Internet and accesses servers resources over Intranets. Device browsers enable users to interact with variety of web resources by activating processes for getting information and posting information. Device Browsers present the activated web resources on the device display, using user interface adapted to the application or information activated.

In some exemplary embodiments, the system information may include updateable data. This updateable data may include without limitations, information files, linking information entities, programs versions information, default user interfaces controls and user interface presentations.

The software may be provided as a computer program product which may include a computer-readable medium having stored thereon instructions, which, when read, cause a computer (or other electronic devices) to perform a process or method. The computer-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/computer-readable medium suitable for storing electronic instructions. Moreover, the software may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a computer-readable medium. In some embodiments, some or all of the instructions of the software may be installed on more than one computing device to perform the method using distributed computing techniques.

In some embodiments, of the invention, the information system disclosed herein comprises software modules installed on distributed communicating computerized devices, or on a centrally managed server-system or on a combination of servers and distributed communicating computerized devices.

In certain embodiments of the current invention, the linking of device browsers comprises at least one or more of the following:

Linking a first device browser in a first device window with a second device browser in a second device window wherein the second device window may comprise of window add-on of the first device window. (An add-on is an additional computer software module that supplements or enhances the original unit they are adding on to):

Transferring parameters from a first device browser in a first device window, which accesses a first web resource to a second device browser in a second device window for the access of a second web resource.

Presenting a first web resource information in a first device window, presenting a second web resource information in a second device window or window's add-on;

Presenting the browsers linking and management functions keys, in an accessible user interface in the device windows or windows add-ons;

Managing the browsers' linking configurations including such as unidirectional linking and bidirectional linking between the browsers, archiving and retrieving browsers' linking information entities, assembling and disassembling the links of browsers, enabling global setting and releasing of browsers linking configurations;

Generating a linking information entity that defines the browsers linking and synchronizing configuration and the parameters transferred between the linked browsers;

Archiving the linking information entities;

Sharing the linking information entities;

Enabling controls keys for assigning web resources and the associated Uniform Resource Identifiers (URIs) to device windows and to device window's add-ons for such controls as transferring web resources between devices' windows or between windows and windows' add-ons or between windows' add-ons and windows;

Enabling linking between multiple device browsers associated with sets of tabs at say first device window and multiple device browsers associate with sets of tabs at a second device window wherein second window may also comprise of a first window add-on;

Linking browsers in multiplicity of linking configurations, such as linking a single or multiple Browsers to a single or multiple browsers with either one or two directional links in between browsers;

Enabling a default setup of browsers with predefined linking information entities and related linking parameters configurations and enabling other browsers to transfer their default linking information parameters to the default setup of browsers to activate web resources based on their transferred linking information;

Enabling first browser to be linked to a group of browsers wherein the first browser access a web resource and retrieve certain web resource parameters, (such as for example key words), transfer the parameters synchronously or asynchronously to the linked browsers to activate a similar or related operations, such as activating a different searches using different search engines based on the transferred parameters;

Enabling a second browser to synchronously activate a second web resource such as a search engine, searching for web resources based on parameters retrieved from a web resources activated by a first browser linked to said second browser, wherein the said parameters may deducted from items such as the first web resource URI/URL (URI—Uniform Resource Identifier; URL—Uniform Resource Locator), key words, tags, titles, language and streaming content parameters as well as words inside a web resources documents, hyperlinks and hyperlinks related sites;

Enabling a second browser to synchronously activate a search engine, searching for related blogs, or websites or audio content, or video content, or articles, or products, or services, or comments or polling or advertisements based on parameters retrieved from a web resources activated by a first browser linked to said second browser, wherein parameters may deducted from items such as the first web resource URI/URL, key words, tags, titles, parameters and words inside a web resource documents, first web resources hyperlinks and hyperlinks related web resources and sites;

Enabling a default second browser to synchronously or asynchronously activate a web based language translation engine, for the translation of web resources accessed by a first browser;

Enabling a second browser to synchronously activates a second web resource from a web site based on parameters deducted from a URI/URL of a first web resource activated by a first browser, wherein the second web resource comprises of information such as advertisements, comments, polling, text of an audio content streamed by the first browser, text or audio or audio visual content streamed in a selected language containing the translation of text or audio or audiovisual content accessed and presented by the first browser;

Enabling a second browser to synchronously activate a second web resource of a second web site based on parameters from the first web resource activated by a first browser, such as URI/URL, keywords, Metadata of the first web item, wherein the second web resource enables users to post information such as advertisements, comments, polling, create forms and other social networking related applications;

Enabling the automatic presentation of the location of the accessed website by an active browser in a visual form, such as a flag of the website hosted country, a text format of the name of the hosted location or both during the presentation of the web resource;

Enabling the presentation of the browser accessed website's response time (for example by polling the web site) to enable the user to identify the preferred accessed web sites based on the required application response time;

Enabling the sharing of linking information entities between device browsers on multiplicity of computerized devices wherein the linking information between linked browsers are communicated using such as peer to peer linking, or via web servers; and

Enabling the linking of browsers activating web resources, which perform processes such as: voice over IP (VOIP) linking, linking audiovisual content, linking gaming content and linking control systems.

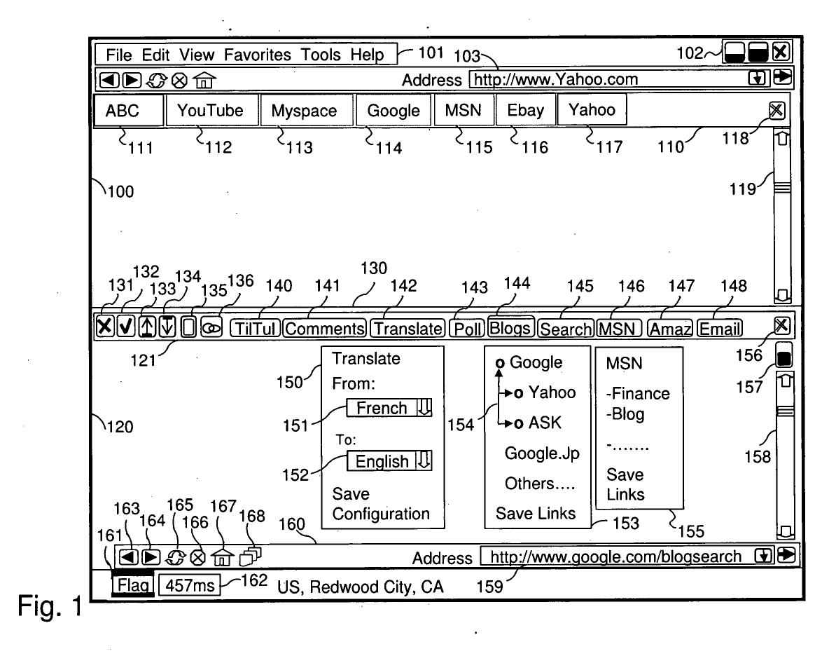

FIG. 1 is a schematic exemplary representation of a User-Interface presentation of the current invention. The presentation described in FIG. 1 relates to the presentation of linked browsers set-up, functionality and activation on computerized devices' windows type displays. The User Interface can be adapted to fit UI of network connected Television Mobile devices with limited display size and other computerized networked devices.

FIG. 1 describes multiple examples of linked browsers configurations and demonstrates variety of system capabilities using presentation on a split-window User-Interface (such as a main web browser window and its window add-on). FIG. 1 also shows examples of variety of linked browsers related activation functions, functions keys and both fixed and popup menus related to automatic set-up of linking browsers. The user interface example of FIG. 1 comprises of a display of a first device browser in a first device window 100 (main window) and a second device browser in a second device window 120 shown at the lower part of the display.

The system activates and deactivates automatically the linked browsers' tabs in the second lower window 120, based on the selected browser tab in the first window 100. Thus, linked groups of browsers tabs are being activated and displayed to the user in the second window 120 based on the selection of browser tabs in the first window 100. The system also automatically closes the group of linked tabs in window 120 once the user selects a tab in window 100 which the tabs in window 120 are not linked to it. The other second device window 120 can be implemented as a window add-on to the current art main web browsers windows, (Muzilla Firefox, Microsoft Explorer, Safari, Opera and others) as well as side window, a separate window or windows located on other areas of the device display.

The first window 100 User Interface is very common and comprises the first browser bars and functions keys 101, 102 and 103. The 101 common functions include among others the handling of File, Edit, View, Favorites or Bookmarks, Tools and help. 102 includes the common keys for minimizing, maximizing or closing the window. 103 includes common navigation and browsing functions such as insertion and display of the URI/URL address, Go Back one page, Go Forward One Page, Refresh, Stop, Go Home. Other functionality keys and additional utility bars are commonly added to browsers windows to facilitate user activation of functions.

Common additions of the current art may include direct accesses to a search engines, RSS/ATOM feeds, news information and other sites. Certain device browsers use multiple browsers tabs inside a window, where an access to each web resource's URI/URL are assigned to a dedicated Tab when opened by the user. The multiplicity of window 100 tabs are described by tabs 111, 112, 113, 114, 115, 116, and 117.

The user or program can open a new tab, assign it to a defined browsing operation of a web resource. Thus, the user is able to get direct accesses to web resources by manual activation of the desired Tab inside window 100. 118 is a “close Tab” key which enables the closing of each selected web resource's tab on the bar 110. In certain browsers, 118 functions assigned to each tab separately. 119 is a vertical window scroll bar, which enables the user to display a section from a retrieved web resource page. A horizontal window scroll bar may also exist if the web resource presentation extends beyond the window display, but for purpose of clarity, it is not shown in FIG. 1.

Following the selection of one of the browsers' tabs on bar 110, a browser activates the web resource assigned to the Tab and presents the retrieved information in the first window 100. In FIG. 1 the second browser window (or a window add-on) of the current invention 120, is shown in an open position at the lower part of the display.

According to certain embodiments of the current invention, the window 100 presents a first browser with inputs from for example the selected web resource tabs 111-117 and the window 120 presents other browsers with inputs from for example other selected web resources assigned to Tabs in window 120. According to certain embodiments of the current invention, the browsers and the web resources can be linked in verity of configurations. Thus, the browsers can access automatically different web resources based on the linking configuration and based on parameters retrieved or defined by the web resources accessed.

When the window's Add-on 120 is closed (by for example activating keys 131 or 161, or “Close Window” from a menu on the right mouse bottom), the main window 100 information from the selected browser's activated web resource is presented on the entire display screen. By moving, the display separator 130 of the open window 120, up and down the user is able to adjust the vertical split of displays in any ratio size between the first browser web resource presented in window 100 and the second browser web resource presented in window 120. In FIG. 1, 120 could be a browser window add-on of a main window or other windows positioned on the same display. Multiple windows can be opened by the system simultaneously in different configurations such as one on top of the other or windows embedded in each other based on the linking topology of the selected browser group.

The second browser window (for example the browser window Add-on) 120 of FIG. 1 has for example a function and application bar 121 which contains both functions keys 131-136 and browsers tabs 140-148. Some examples of the functions keys shown are:

131—Close window—key, use for the closing of the second browser window 120 (or window Add-on),
132—Global Connect or global disconnect all the linked browsers and their web items in the window (120).
133—Copy the selected web resource from the second browser window 120 to the first browser window 100. (Open the same browser and web resource tab presented in 120 in window 100) This function key enables the user to activate automatically in window 120 the other browsers that are linked to the browser and web resources transferred to window 100.
134—Copy the selected web resource from the first browser window 100 to the second browser window 120. (Open the same browser tab presented in 100 in window 120)
135—Open a new tab in the second browser window 120 (or window Add-on).
136—Link or unlink the selected (or marked) web resources' tabs at the first (100) and second (120) browsers windows. The link/unlink of the selected web resources, is activated by, for example, selecting the browsers web resources tabs in the first browser window and the second browser window and then activating the link/unlink function key. Following the linking activation, the linked web resources tabs are marked by a “linking tag” in order to visually identify them as linked web resources tabs. The “linking tag” may include for example a tab symbol or a tab color that identifies the linking and unlinking status of the web resource tab.

The current invention also comprises different type of marking of web resources tabs (also referred as browsers tabs) such as:

Marking of web resources related tabs as Linked or as Unlinked; Marking the web resources related tabs with such as marking symbols, colors, flashing, sign of speaker, sign of TV; identifying their linking properties such as permanent tab or belonging to a group of web resources tabs; marking the web resources related tabs with marking identifying their activity such as streaming audio, streaming video, streaming text information; Linking type marking such as unidirectional linking, bidirectional linking configuration, other type of group linking such as between web domains or between web pages and web domains, permanent linking of web resources to a specific window, temporary linking; marking the activity of the web resource marker such as displaying a mark when a new e mail arrives to a mail-box web resource tab.

The “Linking Tag” or marker attached or assigned to the web resource tabs (not shown in FIG. 1), the transferring between windows of web resources and the associate function keys enabling those functions, the linking or unlinking of web resources related tabs, the book-marking of linked tabs are all unique embodiments of the current invention.

According to another embodiment of the current invention, the user (or the program) can define if a link is one-directional link (unidirectional link), or a two-directional link (Bidirectional link). A unidirectional link defined when activating one browser's web resource activates another (second) browser's web resource. A two directional linking (or bidirectional link) defined when one browser web resource activates a second browser's web resource and the activation of the second browser's web-item activates the first browser's web resource.

In another embodiment of the current invention, the function Keys 133 and 134 are capable of being a programmable function Keys for the transferring command of “web resources” from one browser's window to another browser's window. The transfer command could be programmed to activate a transfer between browsers on the same computerized device such as from the second browser window 120 to a first browser window 100 (or vise versa), or from a browser operating in a window on a first computerized device to others (one or more) browsers operating on multiplicity of computerized devices windows. 140-148 are tabs assigned to activation of the browser web resources in window 120.

The multiplicity of URI/URL web resources' access tabs of window 120 are shown by the examples of tabs 140, 141, 142, 143, 144, 145, 146, 147 and 148. The user or program can create new access tabs in window 120, for example, by activating key 135 (open new Tab) or key 134 (transferring marked web resource tab from bar 110 to bar 121). Web resources tabs can also be created in window 120 by activating previously bookmarked web resources' URI/URLs, activating hyperlinks inside a web resource such as web page, activating linked web resources' URI/URLs linked to web resources' URI/URLs in other browsers and by programmable processes. The right mouse menu can be used to define in which of the windows the web resources is activated and presented.

When activating the web resource's tabs 140-148, the browsers of window 120 access the assigned web resources via the web resources' URI/URLs and activate the web resources associated with the URI/URLs. According to the current invention, activating the tabs may include activation of additional programs for tasks related to linking between Resources Identifiers (URIs/URLs), linking between web resources and linking between browsers.

156 is a “close Tab” function key, which enables the closing of each selected web resource's tab on the bar 121. The function key of 156 can also be implemented and presented on each one of the open tabs on bar 121. (not shown)

157—is a window 120 size adjustment key of the current invention browser window or window add-on. It allows the user to click the 157 key in order to increase or decrease the size of the window 120 in fixed defined sizes. For example it can be set to enable the user to modify the window 120 size to cover certain defined areas such as ¼; ½; ¾, 1 of the available display area.

When modifying the size of a window add-on 120 the main window 100 is adjusted respectively to cover the complementary space of both windows together. When multiple windows are displayed for example one on top of the others' displayed area or on different areas of the device display, according to the current invention each window can include its own window add-on and its own linked browsers and web resources. Windows and tabs displayed in a first device can also present windows of linked browsers activated by other computerized devices networked with the said first computerized device.

The vertical size of window 120 can be adjusted to different levels as commonly done, by moving separator line 130 on the upper side of bar 121 using for example the computer device mouse pointer. 158 is a vertical window scroll bar, which enables the user to display sections of retrieved web resource presentation (such as web resource page or video stream) on window 120. A horizontal window scroll bar may also exist but for purpose of clarity is not shown in FIG. 1. 160 is a toolbar and a function bar for the window 120 of the current invention. It may include the common navigation and browsing function keys, such as the browser web resource URI/URL address display area 159 of window 120, Go Back one page 163, Go Forward One Page 164, Refresh 165, Stop 166, Go Home 167. Other functionality keys and additional utility bars can be added to the browsers windows 120 to facilitate user activation of functions.

According to another unique embodiment of the current invention, a novel Linking browsers bookmark key 168 is shown in toolbar 160. The 168 function key enables the user to access a library of bookmarked linked browsers web resources configurations, retrieve and activate them. The user can also use 168 to bookmark (save) a linked browsers web resources configurations. The bookmarked linked configuration can be saved locally on the user device as well as on remote websites and computerized devices. Thus other devices can access the linked browsers configurations and their linked information entities.

In another embodiment, the current invention introduces a browser window add-on function key and “active Image” button 161. 161 shown as a “Flag” key and is implemented for example on the left side of the lower bar of the main window of FIG. 1. 161 can be assigned multiple functions; for example, it may serve for opening and closing window 120. 161 positions on the lower left side of a window lowest bar, is especially useful as it is also shown when the main window 100 is reduced in size or window 120 is closed. In one embodiment of the current invention the Flag 161 can displays the “country flag” of the country where the accessed web site's hosting server is located. The accessed web resource URI/URL, together with the IP address of the site are correlated with the site location information (retrieved from other web resources) and presented by the Flag of the site country to help the user identify the site location in real time. More information related to the web resource presented in window 100 (or window add-on 120) such as web item's safety and web site popularity, can be retrieved simultaneously from other web sites resources.

162 is an “active Image” display presenting the response time of the accessed web site. The response time can be measured, for example, by executing a ping operation from the user computerized device to the accessed website selected for example in the main window 100 or add-on window 120.

The presentation of the website's country location using the flag 161, the written description of the site location and the site response time 162 (displayed for example in ms—milliseconds) on the lower bar, enables the user to evaluate if the website resources should be accessed. Additional information such as level of site risk and other users' comments regarding the same web site can be retrieved from posted “comments” related web sites by activating linked browser via web resource tab 141.

According to the current invention, Browsers associate with web resources activated by selecting tabs 111-117 in window 100, can be linked to browsers associated with web resource tabs 141-148 in another window or window add-on 120. One example of the current invention is related to activation of automatic real time language translation of web resources such as web pages and the display of the translated web resource information, synchronously and simultaneously with the source web resource on the user's computerized device display.

In the translation example, the user interface is shown by a pull down menu 150, which enables the user to select the web resource source language 151 and the language it should be translated to 152. The linking information entity program can, also determine the source language of 151, if for example the web resource language information is included in the web resource meta data.

The default destination 152 of the language translation could be determined for example from the browser default language set up. Following the set up of 150 and the activation of the “Translate” key 142, the linking function entity will activate a second browser in window 120 that will access language translation engine on a translation related web site and will transfer the URI/URL of the selected web resource in window 100 to the translation engine on that web site. The results of the language translation will be presented in window 120.

Modifying the browser's web resource URI/URL in Window 100 when browsing in the first window, the system updates the information transferred to the active browser in window 120 and simultaneously synchronizes the language translation information displayed in 120. Thus while window 100 displays a first browser web resource, window 120 displays synchronously the translation results of a second linked browser. The linking function entity of this example, defines among other the linking configuration, the translation parameters, the language translation web sites, and the parameters the browser should transfer to the language translation site to activate the proper translation. The configuration set up of 150 can be saved in a book-marking file so that the user can recall it for repeat translation of the source web page. For example a newspaper web page which is updated at least every day, may have the same URI/URL, nevertheless it will be book-marked using the same translation configurations in order that its translation could be activated directly from the book-marking menu in the future.

The advantage of the current invention may be shown in the translation of information or web resources when the system automatically activates multiple translations engines to translate the web resource. The user can compare the different automatic translations by switching between the browsers' tabs which accesses the different translations engines. It has been shown experimentally that different engines deliver different translations results.

More over the system design enables the user to define translation of either web page or selected paragraph, or inserted text, using multiple translation engines. In addition the user can translate to multiple different languages and in each language the system can activate multiple translation engines from web resources. The results from the multiple simultaneous translation are assigned to separate Tabs and can be presented by the user selecting those tabs. The multiple translation engines configuration is not shown in FIG. 1, but was shown to perform well and delivers very useful comparative translation results reducing the current art of manual setup operation.

The pull down menu 153 of FIG. 1 describes another example of linking and synchronizing a group of browsers based on the current invention. A first browser selected in window 100 by for example activation the Google tab 114. Following the inserting of a search item in the Google web page and activating the search engine, the site will display in window 100 the retrieved search results. When activating the Search key 145 the linking function entity will transfer the inserted search items and other parameters to the selected browsers of the other search engines such as Yahoo, ASK, Wikipedia (not shown) and other selected websites search engines (Default groups or user defined groups), as shown for example in the drop down menu 153. The browsers associated with the search engines of Yahoo, ASK (schematically shown at 154) and other selected websites search engines, will retrieve the search results from all the accessed web sites. The linking function entities activate the web resources related tabs associated with the active browsers and present them on the bar 121 to allow the user to select and display any one of the browser's web resources results.

According to another embodiment of the current invention the linking of a group of browsers can be set up to be either unidirectional or bidirectional links in between each pair of browsers and their web resources. When a bidirectional links are set up in between each pair of browsers and their web resources, the user can insert for example search items in either one of the linked browsers and following an activation of the search, the system will activate a search for the same item on the other linked browser.

As an example, a first search browser results can be displayed in window 100, while the rest of the linked browsers have their web resources tabs opened in window 120 on bar 121. When a user selects one of the tabs of one of the linked web resources, the browser accessing the related search engine will present the results in window 120. The linked browsers search simultaneously for the same item that the first browser is searching for, but using the search engines as defined by the linking information entity. Thus, the user can display in window 120 each one of the other browsers' results, by activating their related web resources tabs.

One of the main advantages of the automatic linked browsers system of the current invention is its fast simultaneous retrieval of results from the accessed web resources, such as search results by the multiple linked browsers and the accelerated presentation of the retrieved results by the user, via activation of a selected browser's web resource tab. The automatic preprogramming setup, delivers much faster response time than the current manual activation of each browser and the repeating of manual insertion of same search items at each one of the websites.

As an example, in FIG. 1, 154 displays graphically the linking of Google web resource to yahoo and ASK web resources in bidirectional links, using dual head arrows. When an item is searched in Google for example by activating Tab 114 in Window 100, the results will be retrieved simultaneously from the browsers of Google, Yahoo and Ask. If a search item is inserted in yahoo by activating a search using Tab 117 in window 100, the system will also retrieve the results from Google and Ask. Google and ASK tabs will be opened on bar 121 automatically, one of the tabs according to a defined priority will be selected thus enabling the user to view simultaneously the Yahoo search engines retrieved results in window 100 and for example Google or Ask results in window 120.

Another way of operating the search using the current invention is by first activating a search for an item in window 100 when window 120 is closed. I the user decides to expand the search with results from other search engines, the user opens window 120. Upon the opening of window 120 the system automatically activates the linked browsers with the same search items and access the other search sites retrieving the results to tabs in window 120. When the search items are modified in window 100, automatically the search items and the format parameters are modified to fit the search engines in window 120. Upon selecting another tab in window 100 the system will close the linked tabs in window 120 and if the newly selected browser has links to other browsers, the system will automatically open those other browsers in new tabs in window 120.

To deactivate the automatic linking processes between browsers in windows 100 and 120, the user can activates Key 132 which stops the linking and allow each window to display its own selected browser activity.

According to the current invention, the user can move web resources tabs from one window bar to another window bar. For example, browsers tabs accessing web resources on bar 121 of window 120 can be copied to bar 110 of window 100 using key 133. Key 134 copies browsers tabs from window bar 110 to window bar 121. In this example the user defines which web resource is displayed in which window and which one of the browsers is the master (by locating it for example in window 100) in activating and synchronizing the other browsers in the same group. The other browsers are automatically open in for example window 120.

According to another embodiment of the invention when one of the browsers of a group is selected to be presented in a first window, say window 100, it serves as the master browser for the other linked browsers presented in other windows, for example window or window add-on 120, or other windows or other tabs in the same window.

A unidirectional configuration between search engines at websites can be described by the following example. Google 114 is selected as the master search site used by the user to insert the item to be searched. The linking function entity automatically activates a search for the same item at the Yahoo and ASK websites as defined by the unidirectional linking configuration of the browsers. Thus, an item inserted for search in Google will simultaneously activate a retrieval of search results from Google Ask and yahoo search engines. The search results from Google 114, will be presented in window 100 and the results from YAHOO or ASK (if Yahoo or ASK Tabs are selected respectfully) will be presented in Window 120. If more windows are opened simultaneously each one of the search results can be displayed in its respective window. However since the defined link is unidirectional, if an Item is searched in Yahoo by selecting browser tab 117 for example, or in ASK either in window 100 or 120, it will not initiate a linked search in Google.

Users can setup the linking configuration of the groups by editing the linking function entities on their computerized devices (using for example linking set up key 136), or for example by downloading preconfigured linking function entities from remote servers. The user linking function entity can be stored in the user's bookmarked folders or retrieved from the user's bookmark folders (stored locally or remotely) by selecting the linked browsers web resources tabs and activating the bookmark key 168. Users can e-mail the URI/URLs of locations pointing to linking information entities sites, enabling other users to retrieve and activate the same linked browsers and web resources configurations on their devices.

In another exemplary embodiment of the current invention, the Resource Identifier information, such as the Unified Resource Identifier (URI) of a first browsed web resource is used by the linking information entity to enable a linked browser an access to a second web resource in another website and retrieve or post web resource's information with links to the URI accessed by the first browser.

As an example of the current invention, a “comments” website is setup, comprising of posted comments and posted advertisements related to other web resources located on other web sites. The accesses to the posted comments is done automatically by linking browsers using the URI/URL (or parts of the URI/URL) of the first browser web resource as parameters to construct the URI/URL of the linked browser web resource.

Activation of the “comments” key 141 for example, will activate a second linked browser in window 120 which access a second website and web resource, retrieving the comments “attached” to the URI of the first web resource, accessed by the browser in the first window 100 of FIG. 1. The second linked browser access a second website, where its information is archived by references to the URIs of the first web resource. The “comments” key 141, can also used to access a web resource for posting information such as comments, advertisements and responding to comments posted by others related to the first web resource. The posted information is archived and accessed using the first web resource's URI (or parts of it) as parameters for the creation of the second related web resource URI.

In another embodiment of the current invention, the information attached to a unified resource identifier (URI) of a first browser is a polling information accessed by activating key 143. The polling information could be posted retrieved or polled by the user using a second browser activated in window 120. Wherein the second browser access URI is related to the URI of the first browser in window 100.

In another embodiment of the current invention, certain information or parameters extracted from the Unified Resource Identifier (URI) of a first browser web resource are used for searching of blogs sites with information related to those web resources. Thus the activation of the Blogs key 144 of FIG. 1, activates a second browser that access blogs' search engine at a website such as Google Blogs' search and continuously follow the selected tabs in window 100 search for related blogs and synchronously presents the retrieved results in window 120.

In another example of the current invention, a user can define links between a browser accessing a web resource at a first website such as MSN financials and a linked browser accessing related financial message board or Blog as described in the pull down menu 155 of FIG. 1. The Stock sticker parameters are inserted in the first browser in the stocks search engine, by activating the MSN web resource tag 115 in window 100. The linked browsers automatically access the MSN-Blog and the MSN-Finance web resources, retrieve the related stock information and present the selected web resources in window 120.

When searching for a quote on a stock, for example at MSN Finance (or Yahoo finance) web sites, the shares symbol parameter can be used to define the URI for the same stock's Message board, or the same stock blog as shown in the menu 155. The configuration can be saved by using the window 120 bookmaking key 168, or preprogrammed as a permanent tab, to be displayed for example on the Bar 121.

Tabs can also be displayed on other locations or other forms on the device display, such as the sides of the window 120 or below the bar 121, window 120 can also be displayed on the left or right side of window 100 or in other selected locations on the device display. The access keys to the web resources can also be displayed as bookmarks' hyperlinks words or hyperlinks on web page, where each hyperlink defines a group of linked web resources, such as “search”, “video” “shopping” by activating the related linking information entity.

In another embodiment of the current invention, a permanent or programmable permanent tabs such as Email tabs (shown schematically as tab 148) can be set on Bar 121 (using for example the linking setup function key 136, or pull down mouse menu). According to the one embodiment of the current invention, the browsers related to permanent tabs access automatically the web resources when the related Tabs' window opens (by for example clicking on key 161)

When activating the Email tab 148 its browsers access the web Emails sites resources associated with the tab, retrieve the web items in the destination URIs and have them available for presentation in window 120. The E mails tabs can also be linked to tabs in window 100 using the 136 key. For example, Yahoo Email can be linked to the browser accessing yahoo portal via tab 117 in window 100. Thus activating Yahoo tab 117 will simultaneously activate the retrieval and the presentation of emails from Yahoo Email account in window 120.

When multiple emails accounts are linked to Yahoo 117, they all will be accessed simultaneously when the Tab 117 is activated in window 100. The email tab 148, can be used to present each of the retrieved emails by scrolling between the emails. The Email key 148 can also be expanded to multiple emails account selections in a drop down menu, or expand to multiple tabs, each one retrieves and presents its related linked email account content. The Email linking configuration is initiated by the Linking function entity and the configuration can be saved using the bookmarking key 168. Once the linking function entity is saved, it can be ported to other computers and if the user Email access code is used it can also be activated from other computerized devices. Each one of the accessed sites (e.g. E mail sites) apply its own security accesses code for the accessed user.

Another embodiment of the current invention relates to Groups linking according to their subjects. A group of websites can be connected using unidirectional or bidirectional connections, however certain member of the group can also be connected to other groups members. For example, opening Yahoo 117 in window 100 automatically activate group of browsers and web resources that access the search engines in Google, ASK, Youtube, myspace and displaying their Tabs on bar 121.

When Youtube 112 tab is activated in bar 110 of window 100, it automatically, activates a group of linked browsers that access for example a group of video related web resources in web sites such as, Google-video, Yahoo-video, Ifilm and others as defined by the linking information entity. The linked browsers' web resources Tabs appear on the Bar 121 of window 120 and each one can be selected by the user to be presented in the window. A search in window 100 of Youtube 112 activates simultaneous search of the linked browsers for the web resources in their web sites and presenting the selected web resource results in window 120.

The user can selects one of the group tabs for display in the window and the already retrieved information is displayed immediately in window 120. In this way, the access of the user to web resources information from multiple sites, is done in much increased rate relative to a manual access to each site individually. The tabs grouping can be set by the user or by the server based on user's profile, such as country language age and sex. As an example the definition which tabs to display on the windows may be controlled from remote site, if for example the user enables this function.

In another embodiment of the invention when a tab represents an advertisement entity for example, the amount of times a user access a tab, can be monitored and a monetary charge can be applied to its sponsor. The size and form of a tab can also vary to enhance its appearance for advertisement purposes. The tab real estate size and form factor for example, can be monetized and charged or auctioned to a party associated with the tab.

When a group of linked browsers and their associated tabs are activated, one of the tabs from the group is selected by the user, or selected automatically by the system to be presented on for example window 120. The default selection could be based on multiple considerations such as, user profile, the last web resource accessed, the web site selected by the user or for example it can be related to monetary values paid by advertisement entity for having the web resource tab displayed as a default tab.

According to the current invention, the different ways and processes of monetizing of linked browsers their access to web resources, their related tabs activation and their presentations are all part of the current invention. For examples, monetary charges can be based on the displayed size of the linked browsers web resources tabs (real estate size). Charges may apply for being a member of a certain group of tabs, for the type of a tab, for locations of a tab on the display, for the order of appearance on the display, the presentation time and for the default presentation on the display.

Certain tabs location in device windows of certain users population for example, can be priced and sold directly or can be auctioned. Location of tabs on the Bar such as bar 121 can be changed dynamically based on users frequent use, where the most used tabs may shift to the left or right side for example. As part of the current invention, the system may be used to report the tabs usage to a remote server for purposes such as billing purposes and other related value added services associated with users and merchandizes use of the linking browsers and web resources system.

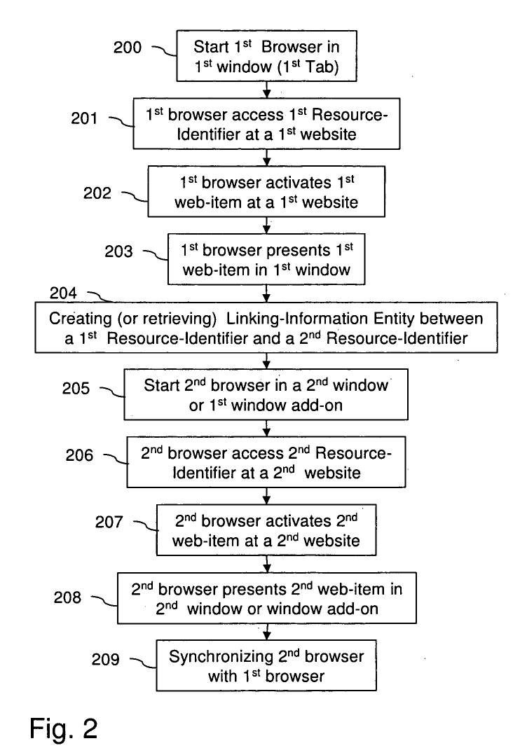

FIG. 2 is a general flow diagram describing the process of linking browsers, according to certain embodiments of the current invention. The process describes the linking of a 1^{st} browser and a 2^{nd} browser. The basic process and method can continue to add more links between the 1^{st} and/or 2^{nd} browsers and their web resources and additional (other) browsers and their web resources. Each browser is related to a web resource identified by its own Resource Identifier (such as URI). The linking process is defined by the Linking Information Entity, which contains the definitions of the parameters used by the browsers to access the specified web resource. The Linking Information Entity can be stored (book-marked) locally on the user device or remotely on networked site and can be used by other systems on other devices to perform similar linking between browsers and web resources.

The process starts at step 200. A browser is started in the 1^{st} window. It is assumed that the browser window supports an operation with multiple tabs, where each tab is assigned to accesses a Resource identifier (such as URI) of a web resource. (Browsers such as Mozilla Firefox V2.0, Internet Explorer V 7.0 support multi window tabs operation).

Step 201; the 1st browser access a 1st Resource Identifier at a 1st website.
Step 202; the 1^{st} browser activates a 1^{st} web resource at a 1^{st} website.
Step 203; the 1st browser presents the 1st web resource in the 1st window of the computerized device. (If the web resource is non presentable then it is handled based on its parameters and specifications).
Step 204; crating (or retrieving) a Linking Information Entity between a 1st Resource Identifier and a 2nd Resource Identifier.
Step 205; start a 2nd browser in a 2nd window or in a 1^{st} window add-on.
Step 206; the 2nd browser access 2nd Resource Identifier at a 2^{nd} website.
Step 207; the 2^{nd} browser activates a 2^{nd} web resource at a 2^{nd} website.
Step 208; the 2^{nd} browser presents a 2^{nd} web resource in the 2^{nd} window or window add-on.
Step 209; synchronizing the 2^{nd} browser with the 1^{st} browser.
If other browsers and their web resources are to be linked to each other, the processes of FIG. 2 repeat themselves to link those browsers and their web resources.

The stage of generating the linking information entity can also be performed after the browsers have accessed the web resources. The generation of linking information entity can also be done to link multiple browsers and their web resources tabs, by marking the web resources tabs to be linked and then defining the linking configuration in between.

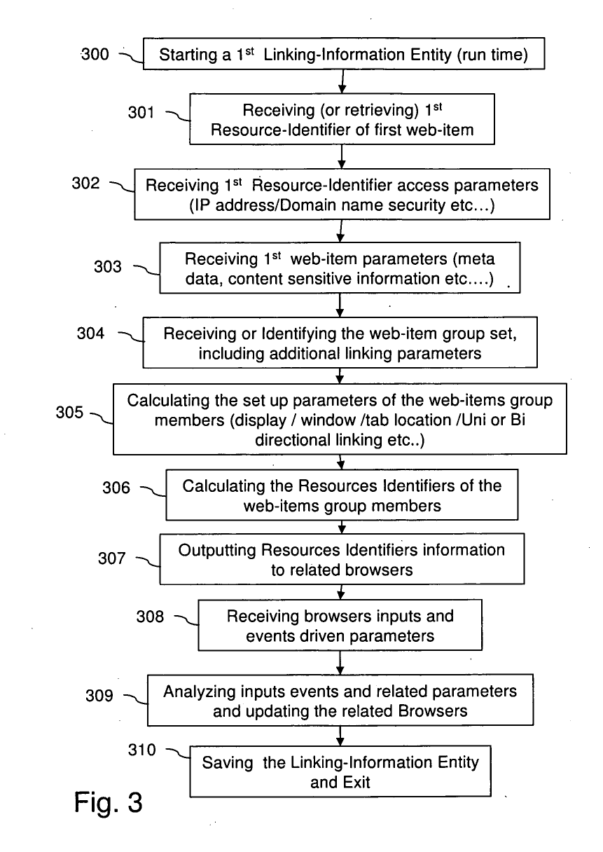

FIG. 3 is a general flow diagram describing the process of creating a Linking Information Entity for linking a 1^{st} web resource, its resource identifier and its related parameters to other web resources accessed by other browsers. The other browsers may operate on the same computerized device and display (via multiple windows or split windows such as windows add-ons) or on other networked devices and displays. FIG. 3 is a description of a process done during a system run time.

300—The process starts by the system defining the 1^{st} Linking Information Entity.
301—The system receives (or retrieves) the 1^{st} Resource Identifier of a first web resource. The web resource's Resource Identifier comprises of such as the web resource's URI/URL.
302—The system receives (or retrieves) the 1^{st} Resource Identifier access parameters, such as IP address, Domain name, security information, information formats etc.
303—The system receives 1^{st} web resource parameters such as web resource meta data parameters, content sensitive information parameters etc.
304—The system receives or identifies the web resource group sets, including additional linking parameters.
305—Calculating set up parameters of the web resources groups members such as, devices displays, displays windows, windows tabs locations/Unidirectional or Bidirectional linking etc.
306—Calculating the Resources Identifiers of the web resources group members.
307—Outputting Resources Identifiers information to related browsers.
308—Receiving browsers inputs and events driven parameters.
309—Analyzing inputs events and related parameters and updating the related Browsers

### 310 Saving the Linking Information Entity.

Saving of the Linking Information Entity can be done on the local device or remote servers or on both.

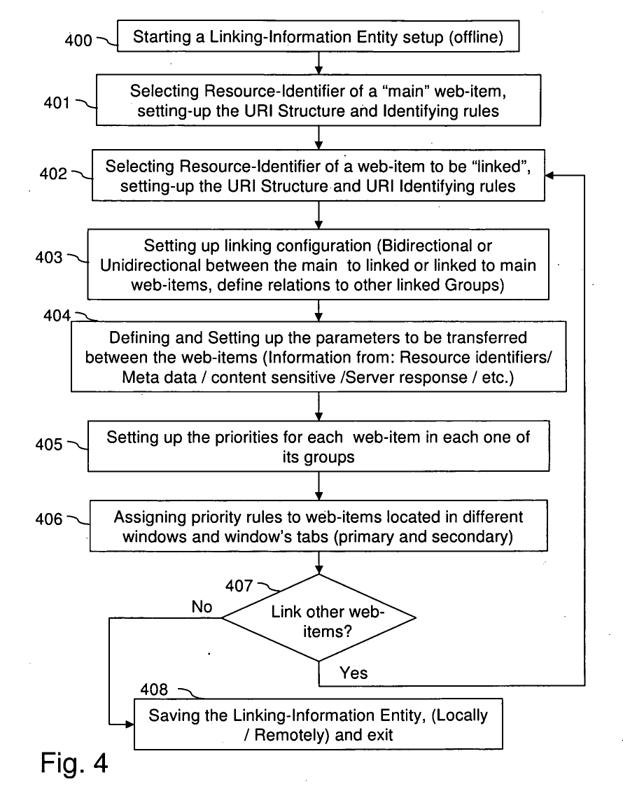

FIG. 4 is a general flow diagram describing the process of creating a Linking Information Entity in offline. The Linking Information Entity defines the linking of web resources, via their Resource Identifiers (URIs/URLs) and their related parameters to other web resources accessed by browsers.

400—Starting a Linking Information Entity setup (offline).
401—Selecting Resource Identifier (URI) of a “main” web resource, setting-up the URI Structure and Identifying rules. The “main” web resource defines as a web resource to which other web items are linked. “Main” web resource may also be defined to be presented in a first (or primary) window wherein the linked web resources are selected to be presented in a secondary (other) window(s) such as window add-on. The setting-up of the Resource Identifier or the URI (Unified Resource Identifier) structure and identifying rules enable:
a. The identification of the URI as a member of specific linking information entity.
b. The calculation of linking information entity for the URI based on the linked parameters.
402—Selecting Resource Identifier of a web resource to be “linked”, setting-up the URI Structure and URI Identifying rules.
403—Setting up linking configuration (Bidirectional or Unidirectional linking between “main” web resource to other linked web resource or between the other linked web resource to the “main” web resource, define the relations to other linked Groups).
404—Defining rules and Setting up the parameters to be transferred between the web resources (Information from: Resource identifiers/Meta Data/content sensitive information/Server response parameters/etc.).
405—Setting up the priorities for each one of the web resources in each one of the groups where it has linking relations.
406—Assigning priority rules to web resources located in different windows and window's tabs (primary and secondary other)
407—Checking if additional Linking to other web resources is required, if yes, the system goes to step 402. If no additional linking to other web resources is required, the system continues to 408.
408—Saving the Linking Information Entity on the local device, or on remote server, or on both (as defined) and exit the process.
RDF—(Resource Description Framework, as defined by the w3c organization), can be used for the persistence storage, exchange and the use of machine-readable information for the distribution of the Linking Information throughout the web.

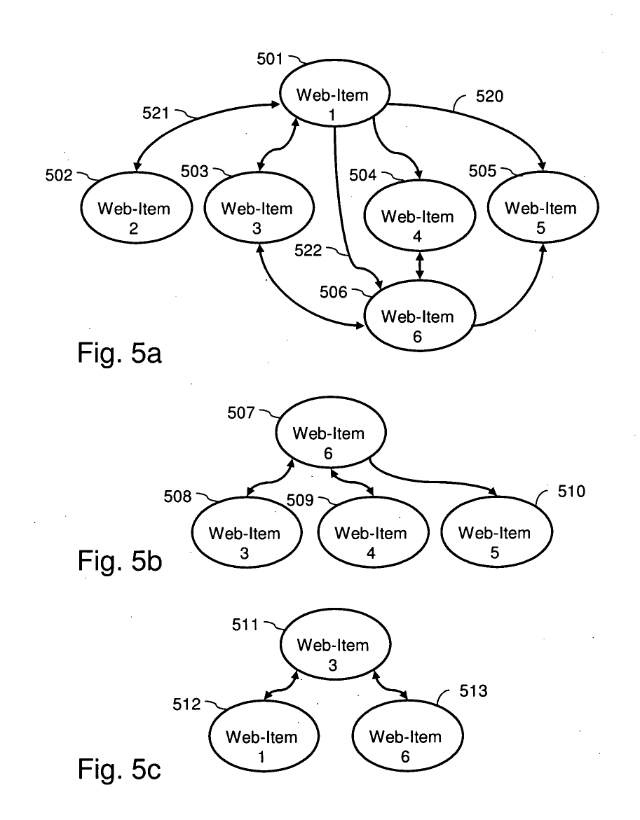

FIGS. 5a., 5b. and 5c. are general examples of diagrams describing the topologies and the linking relations between web resources in groups enables by the current invention. Each link is represented by an arrow, which leads from the 1^{st} (or main) web resource to the linked web resource. When the link is unidirectional, it is marked by one arrow such as arrow 520 which links the 1^{st} (primary) 501 (web resource 1) and 505 (web resource 5). A bidirectional link, is described by the link 521 between 501 (web resource 1) and 502 (web resource 2). The web resource which is accessed via the main window can be defined as the 1^{st} web resource and it automatically links to the other web resources.

FIG. 5a, describes the linking configuration of 501 (web resource 1) as the 1^{st} (main) web resource. When 501 is activated by a first browser, for example in the “main” window 100 of FIG. 1, it will automatically activate other browsers that will access the linked web resources 502,503,504,505 and 506 (web resources 2,3,4,5 and 6) in other window(s). The linked web resources may also be presented in separate tabs in the same or other windows (or window's add-on) such as 120 of FIG. 1. The linked web resources can also be defined to be activated in other windows on the same device display or on different networked devices' displays. Web resource 6 is linked to web resource 1 in a unidirectional link, as described by the arrow 522 from 501 to 506. Thus, web resource 1 can activates web resource 6, but web resource 6 cannot activates web resource 1. Web Resource 6 (506) can also activates web resources 3 (503), 4 (504) and 5 (505) and be activated by resources 3 (503) and 4 (504).

FIG. 5b. Describes the sub-group of web items linked to 507 (web resource 7) when web resource 7 is the primary web resource in the group. A primary web item maybe the resource activated by the first browser for example in the “main” window 100 of FIG. 1. The web resource 7 (507) according to the topology of the groups described in FIG. 5b., automatically activates browsers that will access the linked web resources 508, 509 and 510 (web resources 8,9,10). The linking relations of 507, 508, 509, 510 are similar to those of 506 503 504, 505 of FIG. 5a.

FIG. 5c. Describes the sub-group of web items linked to 511 (web resource 11). When web resource 11 is the primary web resource in the group. The web resource 11 according to the topology of the groups described in FIG. 5c., will automatically activates browsers that will access the linked web resources 512 and 513 (web resources 12 and 13) where 513 activates 511 and 512. This represents the same linking topology of the sub group of web resources 503, 506, 501 in FIG. 5a.

The topology of FIG. 5c. may be described in the following example. 511 (web item-11 similar to 503 of FIG. 5a) is a video/audio stream from a web site such as Youtube assigned to tab 112 in the main window 100 of FIG. 1. When the 1^{st} browser access the URI of the web resource 11 (tab 112 FIG. 1), the video is downloaded and displayed in the main window 100 of FIG. 1. Due to the defined linking information entity, web resource 12 and web resource 13 will be accessed and activated by the other linked browsers.

As an example web resource 12 may comprise of a written translation to a language of a video audio stream displayed in the main window 100 of FIG. 1. When streaming web item 11 (video/audio) the browser transfers synchronization information, for example based on the number of audio packets streamed, and the system uses this information to synchronize in window 120, the presentation of the subtitles retrieved from web item 12.

Other linked browser can retrieve the web resource 13 which comprise of an audio stream in a different language, linked and synchronized with the main video stream 11 in window 100 of FIG. 1. Thus, the user can activates a video stream from web resource 11 (511), link it to different subtitles in other languages from the selected web resource 12 (512) and at the same time selects the audio in the required audio language from a web resource 13 (513) with the required language for the played video stream.

Once the selection of FIG. 5c group is done, the first browser plays video by accessing web resource 11 (511) in a first window, while linking and synchronizing the selected language subtitles of web resource 12 (512) in the second display and also synchronizing the streaming of a selected translated language audio source web resource 13 (513) fed to the device speakers. (Both 512 and 513 can also get the synchronization for the video frames from the audio source 513).

A detailed description example of the current invention is given below for the process of creating linking information entities for browsers accessing Google WEB search, Yahoo WEB search and MySpace site search engines and link them into a group named “search”. The example describes in relation to the offline and runtime operations. The URIs formats in the example below are given as explanatory examples for reduction to practice of URIs formats structures. They can be substituted with other similar URIs to create other examples.

a. creating a Linking Information Entity offline.
Selecting Resource Identifier of a “main” web resource, setting-up the URI Structure and Identifying rules.

Main web resource name: Google WEB search
Linking information entity properties:

Home URI: http://www.google.com/
Domain: www.google.com

Domain template:www.google.com

(Template is a regular expression or a script or any other means for calculating that particular string matches
certain syntaxes rules in this example there is a use of javascript regular expression)

URI prefix: http://www.google.com/search?hl=en&q=
URI suffix: &btnG=Search
Parameters linking symbol: +

```
  Prefix template: http://.*google\.com/.*q=
  Suffix template: &btnG=Search
  Group: search
  Type: parametric
  Priority: 1
  Primary: true
  Secondary: true
```

Main web resource name: Yahoo WEB search
URI structure:

Home URI: http://www.yahoo.com/
Domain: www.yahoo.com

Domain template: www.yahoo.com

URI prefix: http://search.yahoo.com/search?p=
URI suffix:&fr=yfp-t-501&toggle=1&cop=mss&ei=UTF-8
Parameters linking symbol: +

```
  Prefix template: http://.*\.yahoo\.com/(search|results).*\?(p|stx)=
  Suffix template: :&fr=yfp-t-501&toggle=1&cop=mss&ei=UTF-8
  Group: search
  Type: parametric
  Priority:2
  Primary: true
  Secondary: true
```

Main web resource name: MySpace search
URI structure:

Home URI: http://www.myspace.com/
Domain: dewb.myspace.com

Domain template:dewb.myspace.com

URI prefix:

http://sads.myspace.com//Modules/Search/Pages/Search.aspx?fuseaction=advancedFind.results&amp;searchtar
get=tms&amp;searchtype=myspace&amp;t=tms&amp;get=1&amp;websearch=1&amp;searchBoxID=HeaderW
ebResults&amp;searchString=

URI prefix:&q=
URI suffix:
Parameters linking symbol: +

```
  Prefix template: http://.*myspace\.com/.*searchString=
  Suffix template:
  Group: search
  Type: parametric
  Priority:3
  Primary: false
  Secondary: true
```

Identifying set of rules and rules order are all the same for all linking entities and are the following:

Rule “Priority”

Identifies position of the linked entity in hierarchy of linked browsers. The entity with highest priority is shown on the most left tab of linked browser.

Rule “Primary”

Identifies that linking entity might be or not in the main window as a main linking entity.

Rule “Secondary”

Identifies that linking entity might be or not in the linked window as a linked linking entity.
Rule name: “Domain”
Identifies that given domain is equal or not to domain specified in “Domain” parameter of linking entity

Rule name: “Domain template”

Identifies that given domain has or hasn't satisfy to template specified in “Domain template” of linking entity

Rule name: “Home URI”
Identifies that given URI is equal or not to URI specified in “Home URI” parameter of linking entity
Rule name: “URI prefix”
Identifies that given URI is starts or not from the string specified in “URI prefix” parameter of linking entity
Rule name: “Prefix template”

Identifies that given URI has or hasn't satisfy to template specified in “Prefix template” of linking entity

Rule name: “URI Suffix”

Identifies that given URI is or isn't ends with the string specified in “URI prefix” of linking entity

Rule name: “Suffix template”

Identifies that given URI has or hasn't satisfy to template specified in “Suffix template” of linking entity

Rule name: “Parametric URI calculation”
Calculates linked URI based on parameters from main linking entity. If words/parameters from the main web resource are know this particular implementation builds the URI in the following way:
1. Choose all “URI prefix” for given linked entity
2. Create the parameter string by concatenating parameters from main linking entity with “Parameters linking symbol” of given linked entity
3. Choose “URI suffix” as the end string of URI
4. Concatenate all prefixes (1), parameter string (2) and “URI suffix” (3) to create linked URI
b. The identification of the URI as a member of specific linking information entity and the initiation of the linked entities of the group in run time.
Example for runtime: A user made WEB search for two words[video game] in Yahoo search engine. User typed this in Yahoo search window located in the main (primary) browser window. Yahoo search engine response by returning the following URI: http://search.yahoo.com/search?p=video+game&fr=yfp-t-501&toggle=1&cop=mss&ei=UTF-8 (URI-1)
And domain name:
www.yahoo.com (Domain-1)

Then the current invention linking engine needs to identify which linking entity/entities this URI and its domain belongs to and what type/types of linking those entities defines.

In the current example

1. Run time linking engine retrieves the first linking entity (“Google WEB search”)
2. Applies rule “Primary” passed.
3. Applies rule “Domain” result negative
4. Apply rule “Domain template” negative result Linking item “Google WEB search” identified as not matching to given URI/Domain
5. Run time linking engine retrieves the second linking entity (“Yahoo WEB search”)
6. Applies rule “Domain”—passed
7. Applies rule “Domain template”—passed
8. Applies rule “Home URI”—not passed. URI isn't home URI for Yahoo
9. Applies rule “URI prefix”—passed
10. Applies rule “Prefix template”—passed
11. Applies rule “Suffix”—passed
12. Applies rule “Suffix template”—passed

Given URI/Domain been identified as belonging to linking entity “Yahoo WEB search”. That linking entity is part of group “search” and linking type “parametric”. Another members of group search are “Google WEB search” and “MySpace search”. Group search is created to be type “parametric” which means that parameter to be transferred between linking entities are inside URI. In our case that parameter is string “video+game” Linking entity calculates this using the following algorithm:

1. If rule “URI prefix” passed removed from (URI-1) prefix string.
2. If rule “URI prefix” not passed but “Prefix template” passed remove from the (URI-1) the substring which satisfies “Prefix template”. In our case both 1 or 2 gives the same result:
video+game&fr=yfp-t-501&toggle=1&cop=mss&ei=UTF-8 (URI-2)
3. If rule “URI suffix” passed remove from the (URI-2) end of string that equals to “URI suffix”
4. If rule “URI suffix” not passed but “Suffix template” passed remove from the (URI-2) end of string which satisfies “Suffix template”. In the current case both 3 or 4 gives the same result
video+game (URI-3)
5. Calculate original set of parameters that user entered based on “Parameters linking symbol” which defines delimiter between those words.
“Yahoo WEB search” defines this symbol as “+”. Words that this symbol separate are:
video
game
6. Choose linked entities from the group “search” to display in linked browsers and arrange those browsers in order of specified priorities given by rule “Priority”. That rule gives the following order of entities linked to “Yahoo WEB search”:
Google WEB search
MySpace search
7. For every linked entity apply: “Parametric URI calculation” rule. The results are the following URIs:

For “Google WEB search”
http://www.google.com/search?hl=en&q=video+game&btng=search
For “MySpace search”
http://sads.myspace.com//modules/search/pages/search.aspx?fuseaction=advancedfind.results&searchtarget=tm
s&searchtype=myspace&t=tms&get=1&websearch=1&searchboxid=headerwebresults&searchstring=video+ga
me&q=video+game

Wherein video+game are the parameters calculated from main linked entity and underscored prefixes and suffixes

It should be understood that although the current invention is described with many details and examples related to the linking and synchronizing of device browsers, web resources and related user interfaces such as device windows, tabs in windows and window add-on on computerized devices' displays, the invention is also applicable for multiple browsers operating on multiple windows either on single or multiple computerized devices and for accessing items with resources located on the web or on networks additional or other then the world wide web.

What is claimed is:

1. A method for accelerating access to web resources, the method comprising:
a) activating a first web resource using a first device browser and a first resource identifier in a first tab in a first device window;
b) creating linking information entities or retrieving linking information entities that define the linking parameters of the first resource identifier of the first web resource and other resources identifiers of other web resources;
c) activating the other web resources using other device browsers and the other resource identifiers in other tabs in device windows; or other windows; and
d) synchronizing the parameters of the other device browsers with the parameters of the first device browser.

2. The method of claim 1, further comprising at least some of the following:
a) receiving a first resource identifier of a first web resource;
b) receiving the first resource identifier access parameters;
c) receiving first web resource parameters;
d) receiving or identifying a web resources group set and related linking parameters;
e) calculating the setup parameters of the web resources group members;
f) calculating the resources identifiers of the web resources group members;
g) outputting the resources identifiers information to related browsers;
h) receiving browsers inputs and events driven parameters;
i) analyzing inputs events and related parameters and updating the related browsers; or
j) updating linking information in related data storage structures.

3. The method of claim 1, further comprising:
a) selecting a resource identifier of a first web resource;
b) selecting resource identifiers of web resources to be linked to the first web resource;
c) configuring links between said resource identifiers;
d) configuring the parameters to be transferred between the web resources linked in a group of web resources;
e) configuring the priorities for the web resources in their groups;
f) assigning priority rules to web resources located in different windows and in different windows' tabs;
g) updating the linking information in related data structures; and
h) configuring the browsers' tabs locations among device windows.

4. The method of claim 1 further comprising one or more of the following steps:
a) the use of bidirectional linking parameters between browsers;
b) the use of unidirectional linking parameters from first browser to a second browser;
c) the use of unidirectional linking parameters from a second browser to a first browser;
d) creating a permanent assignment of device browsers and tabs in device windows;
e) creating names of web resources groups;
f) creating priority order numbers inside groups;
g) the use of Unified Resource Identifiers (URI) parameters of web resources;
h) the use of IP addresses parameters;
i) the use of group relations parameters;
j) the use of meta data or equivalent data parameters related to web resources;
k) the use of language parameters;
l) the use of translation parameters;
m) the use of data formatting parameters;
n) the use of data style parameters;
o) the use of computerized devices parameters;
p) the use of device browsers parameters;
q) the use of browsers displays parameters;
r) the use of tabs and windows setup parameters;
s) the use of locations parameters;
t) the use of information book-marking parameters;
u) the use of statistical information parameters;
v) the use of timing of information flow;
w) the use of rate of information flow;
x) the use of average rate of audio or audiovisual play;
y) the use of schedule parameters;
z) the use of synchronization parameters; or
aa) the use of unified resources Identifiers related to the web resources sites.

5. The method of claim 1 further comprising the synchronizing of parameters of the other device browsers with the first device browser, and the continuous mapping of parameters of the first web resource to access the other web resources.

6. The method of claim 1, further comprising, linking a multiplicity of browsers to either a single browser or to multiplicity of browsers.

7. The method of claim 1 further comprising one or more of the following steps:
a) activating the said other device browsers in tabs in the first device browser window or in tabs in window add-on of the first device browser window or at tabs in other separate windows;
b) marking the tabs of the linked web resources to identify their status;
c) marking the web resources related tabs with marking symbols to identify their linking properties;
d) marking the web resources related tabs with marking identifying their activity status;
e) enabling the transfer of linked or unlinked web resources between tabs of windows or between tabs of windows and tabs of windows' adds-ons;
f) enabling setup of permanent linking configurations between web resources and permanent tabs;
g) reporting the use of tabs to data handling websites; or
h) reporting the activation and use of selected tabs to advertisers for monitoring or monetizing purposes.

8. The method of claim 1 further comprising the step of activating and synchronizing multiple linked device browsers in tabs in windows on multiple computerized devices wherein linked device browsers retrieve linking information entities from networked servers or from each other.

9. The method of claim 1, further comprising:
activating a first web resource using a first device browser and a first resource identifier creating a linking information entity comprising at least one of the following:
a) language translation parameters;
b) text to text translation parameters;
c) audio to text translation parameters;
d) text to audio translation parameters;
e) activating translation engines or activating retrieval of translated information web resources using other device browsers and other resource identifiers; or
f) synchronizing the other device browsers and their translated web resources with the first device browser web resource.

10. The method of claim 1, further comprising the presentation of audio or visual or audiovisual information of the other web resources in other windows or windows' add-ons or tabs in device windows synchronized with the first web resource information presented, wherein the synchronized information is at least one of the following:
a) text or audio or audiovisual content correlated to information presented in the same time at the first window;
b) translated text information of audio or audio visual content presented in the first window;
c) advertisements information correlated with content presented in the first window;
d) audio content synchronized with visual content presented in the first window;
e) modified information correlated to information presented in the first window; or
f) subtracting, eliminating, replacing or blocking information retrieved from the other web resource to be presented in the other windows based on first web resource information.

11. The method of claim 1, further comprising linking multiple browsers accessing simultaneously at least one object from the following group:
email web sites;
search web sites;
blogs web sites;
shopping web sites;
media websites;
advertising web sites;
comments related web sites;
news web sites;
information web sites;
polls web sites;
gambling web sites;
games web sites;
community web sites;
travel order web sites;
feeds from web sites;
dictionary web sites;
languages translations web sites;
media conversion web sites;
location information web site;
sites security information data base; or
sites information data base.

12. The method of claim 1, wherein the linked browsers and their related web resources are further assigned into groups of tabs in windows wherein activating a first browser tab in a first window activates the first group of said linked browsers tabs and their related web resources and wherein upon activating a second browser tab in a first window the system closes the first group of linked tabs and activates the second group of linked tabs linked to the second activated browser.

13. A device for accelerating access to web resources, the device comprising:
a) means of activating a first web resource using a first device browser and a first resource identifier in a first tab in a first device window;
b) means of creating linking information entities or retrieving linking information entities that define the linking parameters of the first resource identifier of the first web resource and other resources identifiers of other web resources;
c) means of activating the other web resources using other device browsers and the other resource identifiers in other tabs in device windows; or other windows;
d) means of synchronizing the parameters of the other device browsers with the parameters of the first device browser; and
e) wherein the apparatus linking between device browsers has means of being assembled or disassembled by user activating function keys for each one of the links separately or jointly for all the links of a group of linked browsers.

14. The device of claim 13 with a linking information entity with means of being archived and retrieved from a device storage device located on at least one of the following:
a) a device activating the linked browsers;
b) a networked device archiving linking information entities library; or
c) a shared web server that can be accessed by multiplicity of computerized devices for retrieving or saving linking information entities.

15. The device of claim 13 further comprising means for activating identifiable resources from the web (world wide web) or from a web based network, of at least one of the following: web pages, audio streams, visual streams, visual information, advertisements information, advertisement applications, information feeds, computer processes, program scripts, programs which report device or user information or processes, or computer programs.

16. The device of claim 13 with linking information entities further comprising a multiplicity of sets of computer readable medium storing instructions distributed among different storing sites, wherein retrieving of the linking information entities includes retrieving a multiplicity of sets of computer readable medium storing instructions and creating a linking information entities.

17. The device of claim 13 with computer-readable medium storing instructions which, when read by a computer, cause the computer to execute the method of claim 1.

18. A system for accelerating access to information by automatically activating multiple web identifiable resources by linking and synchronizing multiple device browsers in multiple tabs of device windows, the system comprising:
a) means for activating a first identifiable resource using a first device browser and a first resource identifier in a first tab in a first device window;
b) means for generating linking information entities or retrieving linking information entities that define the linking parameters of said first resource identifier of said first identifiable resource and other resources identifiers of other identifiable resources;
c) means for activating the other identifiable resources using other device browsers and the other resource identifiers in tabs in device windows, or other windows; and
d) means for synchronizing the said parameters of the other device browsers with the parameters of the first device browser.

19. The system of claim 18 further comprising at least some of the following:
a) means for archiving the generated linking information entities;
b) means for archiving the generated or retrieved resources identifiers;
c) means for archiving the linking and synchronizing parameters of the device browsers;
d) means for retrieving the archived linking information entities;
e) means for retrieving the generated or archived resources identifiers;
f) means for retrieving the archived linking and synchronizing parameters of the identifiable resources;
g) means for reporting certain information of the linked browsers activity;
h) means for defining the default auto presentation of linked browsers tabs; or
i) means for prioritizing browsers' tabs presentation based on monetizing parameters.
